(19) United States
(12) Patent Application Publication
(10) Pub. No.: US 2004/0206523 A1
(43) Pub. Date: Oct. 21, 2004

(54) Control device for a power impact tool

(76) Inventor: David A. Giardino, Mechanicville, NY (US)

Correspondence Address: Joseph J. Christian, Schmeiser, Olsen & Watts LLP, Suite 201, 3 Lear Jet Lane, Latham, NY, 12110, US

(21) Appl. No.: 10/840,132

(22) Filed: May 6, 2004

Related U.S. Application Data
(63) Continuation-in-part of application No. 10/213,702, filed on Aug. 6, 2002, now abandoned.

(51) Int. Cl. B23Q 5/00

(52) U.S. Cl. 173/176; 173/2

(57) ABSTRACT

A control device for use with pneumatic tools includes a torque limiting timing device and pressure regulator, thereby improving on the accuracy of torque ultimately applied to workpieces. Pneumatic tool with a housing and motor with a control device that is in fluid communication with the tool's motor.

### CROSS-REFERENCE TO RELATED APPLICATIONS

This application is a Continuation-In-Part of copending U.S. patent application Ser. No. 10/213,702, filed on Aug. 5, 2002.

### FIELD OF INVENTION

This invention relates generally to the field of power impact tools and, more particularly, to a control device for a power impact tool and more specifically to timing and pressure regulating devices.

### BACKGROUND OF INVENTION

Power impact tools (e.g., pneumatic, hydraulic, electric, etc.) are well known in the art. Power impact tools produce forces on a workpiece by the repeated impact of a motor-driven hammer on an anvil that is mechanically connected, directly or indirectly, to exert a force on the workpiece. Some power impact tools exert linear forces. Other power impact tools exert torque, which is a twisting force.

One difficulty in current power impact tools is that power may be applied too long to the workpiece. The accumulation of impacts on any already tightened workpiece may cause damage. Current power impact tools shut off when the operator manually enables shutting off. For example, in a pneumatic hand tool such as a torque wrench, the operator releases the trigger valve to shut off the supply of compressed air to the tool motor. The number of impact forces delivered to the workpiece depends on the reflexes and attentiveness of the tool operator. During any delay, the workpiece may become overtorqued and damaged.

Additionally, the user may operate the tool at a higher air pressure than originally designed. For example, the user may operate the air compressor supplying air to the tool without any pressure regulation means. Further, the user then runs the air compressor at higher pressure than intended. As a result, the tool is ultimately receiving air pressure higher than intended, which ultimately may result in torques being applied to workpieces greater than intended.

Accordingly, there is a need in the field of power impact tools for ways to provide more predictable amounts of torque ultimately applied to a workpiece. Additionally, there is a need for a control apparatus that will limit the time that a force of a power impact tool is applied to a workpiece. Additionally, there is a need to regulate the air pressure that is provided ultimately to the tool motor. There is a need in the field of power impact tools a device that provides a method for making a more predictable amount of torque, both in time and amount, to a work piece.

### SUMMARY OF INVENTION

The present invention provides an apparatus and method for use in controlling power impact tools.

A first general aspect of the invention provides a control device for use with a pneumatic torque control tool having a motor, said device comprising:

a pressure regulator, configured to limit a maximum pneumatic pressure provided to said motor; and

a torque limiting timing device, configured to shut off fluid flow to said motor at a predetermined time.

A second general aspect of the invention provides a pneumatic tool, comprising:

a housing;

a motor within the housing; and

a control device in fluid communication the motor.

The foregoing and other features of the invention will be apparent from the following more particular description of various embodiments of the invention.

### BRIEF DESCRIPTION of DRAWINGS

Some of the embodiments of this invention will be described in detail, with reference to the following figures, wherein like designations denote like members, wherein:

FIG. 1A depicts a cross-sectional view of an embodiment of a power impact tool adapted to receive a control device, in accordance with an embodiment of the present invention;

FIG. 1B depicts a cross-sectional view of an embodiment of a control device, in accordance with an embodiment of the present invention;

FIG. 1C depicts a cross-sectional view of an embodiment of a control device constructed from at least two separate blocks, in accordance with the present invention;

FIG. 2 depicts a diagrammatic view of an embodiment of a control device, in accordance with an embodiment of the present invention;

FIGS. 3A-C depict a cross-sectional view of an embodiment of a portion of a control device with the regulator and shut-off valves shown in different operational positions in accordance with the present invention;

FIG. 4 depicts a cross-sectional view of an embodiment of a D-handled tool with a control device that is integrated within the tool housing, in accordance with the present invention; and

FIG. 5 depicts an alternative embodiment of the control device with a fixed metering device, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

The control device is used with, or as part of, a power impact tool and allows for time-limiting the torque output as well as limiting the air pressure ultimately provided to the motor of the power impact tool. Power impact tools can include various power (e.g., pneumatic, hydraulic, electric, etc.) impact tools. This control device, when used with a power impact tool, for example with a pneumatic impact tool, provides a fixed duration of torque from the air motor within the tool, to a workpiece, such as a nut or bolt. This control device also will effectively place a “ceiling” on, that is limit, the maximum amount of air pressure that can be provided the motor. A motor, as defined and used herein, is any device for converting a first flow of energy into kinetic energy. For example, an air motor converts the energy of a flow of expanding compressed gas into the rotational motion of a mechanical drive shaft. For another example, an electric motor converts a flow of electricity into the rotational motion of a mechanical drive shaft. For yet another example, the drive piston and valves of a jack hammer form a motor to convert the energy of an expanding compressed fluid into linear motion of a mechanical drive shaft. For a final example, a hydraulic motor converts the kinetic energy of a flowing, slightly compressible fluid (hydraulic fluid) into the rotational motion of a mechanical drive shaft. The drive shaft, in each embodiment, is rotated by the motor, and tools, for operating on work pieces (workpiece adapters) are mechanically connected directly or indirectly between the drive shaft and the work piece.

The control device may take various configurations. That is the control device may be integrated within a new tool (e.g., within the housing). Conversely, the control device may be a modular unit that may be attached to an existing tool (e.g., at the back of the housing), or attached to a new tool. This attachment may be fixed or removable attachment. Further, the control device may be remote from the tool housing itself. In any embodiment, the control device is in fluid communication with the tool motor.

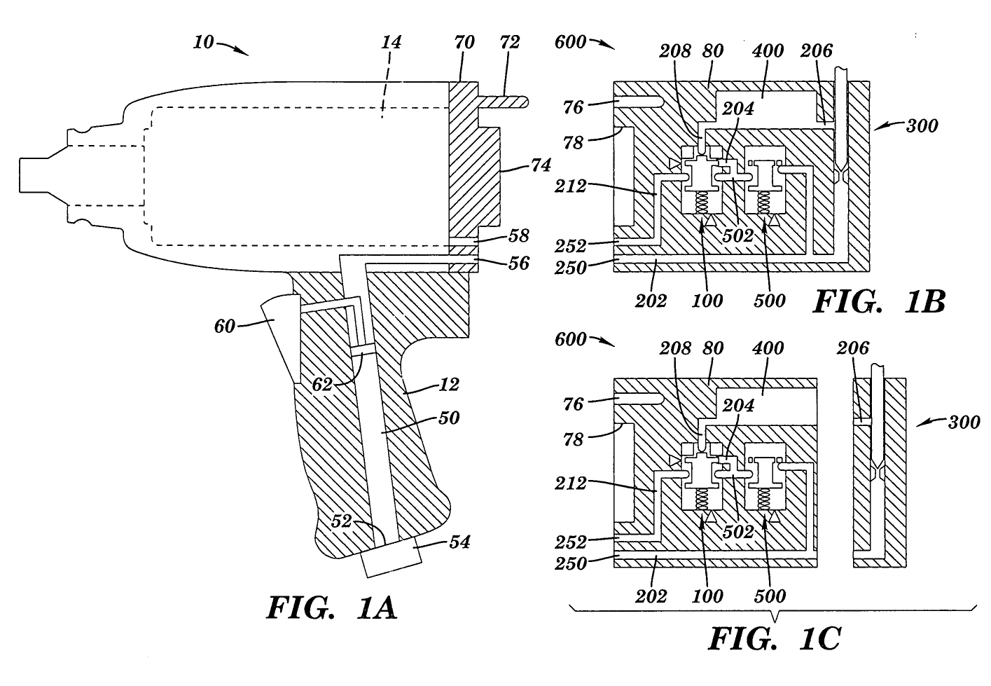

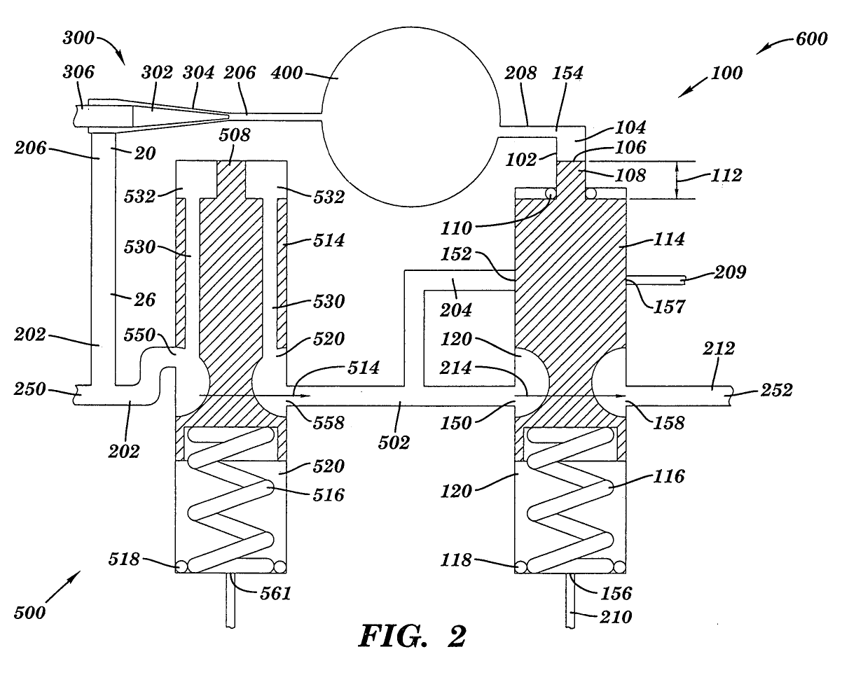

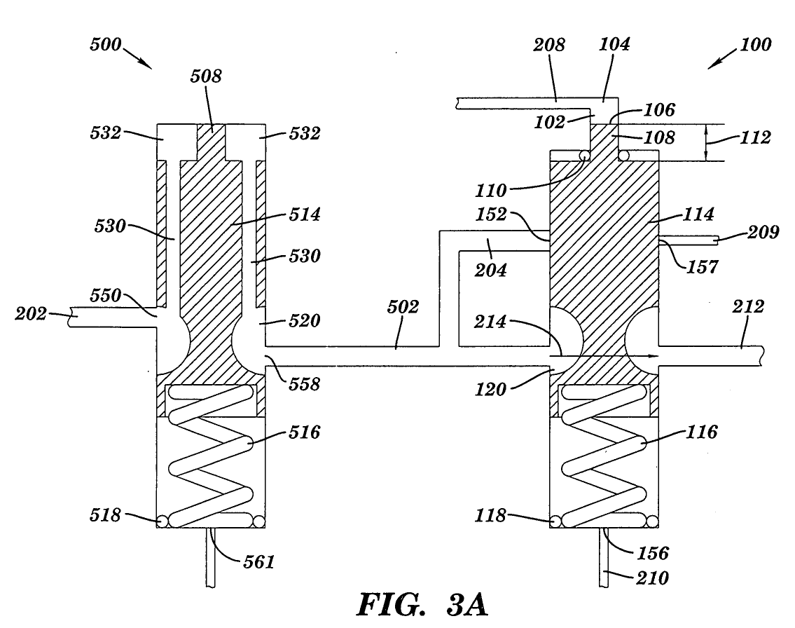

Referring now to FIG. 1A, an embodiment of a power impact tool 10 is shown in a vertical section through the centerline of the tool 10. The tool 10 has a handle 12 containing a channel 50 for receiving a compressible fluid through a port 52 at the base of the handle 12. A channel is a confined path for the flow of a compressible fluid. Channels may be pipes, hoses, bores formed in a block of material, or similar flow constraints.

A compressible fluid, as defined and used herein, is a fluid with a bulk modulus that is less than the bulk modulus of water. Compressible fluids with low bulk moduli transfer energy by converting the potential energy of their compressed state into the kinetic energy of an expanding fluid and then into the kinetic energy of a motor rotor. Elemental gases, such as helium and nitrogen, and mixed gases such as air, are compressible fluids with low bulk moduli. Slightly compressible fluids have high bulk moduli and are used for force transmission. Hydraulic fluids, for example, typically have higher bulk moduli. Either type of compressible fluid can transfer energy into a motor.

The port 52 is equipped with a fitting 54 for connecting to a supply of compressed fluid. A supply of compressible fluid may be, for example, a compressed air hose such as is used in an auto repair shop to power pneumatic tools. Within the channel 50 is a manually operated valve 62, shown in FIG. 1A as a trigger valve 62, which enables the tool-user to regulate the flow of compressible fluid through the channel 50. By depressing the trigger 60, the valve 62 is opened, thereby channeling the compressible fluid toward a motor 14 of the tool 10. The channel 50 extends to a backplate 70 of the tool where the channel 50 terminates at a port 56 sized and shaped to receive (see FIG. 1B) a corresponding port 250 to a first channel 202 in a control device 600. Thus, the first channel 202 is the input channel.

A control device 600 is a first apparatus that controls at least one function of at least one second apparatus. Furthermore, a control device 600 may be modular in that it may be manipulated as a single physical unit (a module). The module comprises a generally solid block, or body, within which are formed the mechanisms which implement control functions. The body may be created from a single block or may be built up from a plurality of sub-blocks. The control device 600 may be manipulated into a relationship with a second apparatus in which interaction between the control device 600 and a second apparatus results in a change in the operation of the second apparatus. For some examples in the field of pneumatics, a control device 600 may shut off air flow to a tool 10 (a second apparatus) after a fixed or user-selected time, may oscillate the direction of air flow, as in a jack hammer, may place a ceiling on the maximum amount of pressure reaching the tool motor, or may change the pressure of the air entering the second apparatus.

The control device 600, in the embodiment shown in FIG. 1B, is configured to be releasably attachable to the tool 10. The apparatus is releasably attachable when the connections between the control device 600 and the tool 10 can be opened and closed by the tool user. The connectors may be bolts, clamps, latches, or similar devices known in the art. In an embodiment, the connections can all be opened or all be closed by a single motion of the user's hand. It should be apparent that alternative configurations of the control device 600 are part and parcel of the present invention. For example, the control device 600 may be fixed to the tool 10. Alternatively, the control device 600 may be remote from the tool 10, yet in fluid communication with the motor 14. Still further, the control device 600 may not be modular at all, but instead be integrated in one, or more, parts of the tool 10 (e.g., housing, handle 12, etc.).

Also located on the backplate 70 is a port 58 sized and shaped to receive the compressed fluid which is discharged from (see FIG. 1B) an output port 252 of a second channel 212 of the control device 600. The second channel 212 is the output channel 212. The backplate 70 may be, for example, the backplate 70 of a Model 749 pneumatic torque wrench made by Chicago Pneumatic Tool. In an embodiment, the backplate 70 has a cylindrical protrusion 74, perhaps accommodating a motor bearing within, which is used an alignment mechanism for aligning the control device 600 to the tool 10.

Referring to FIGS. 1A and 1B, in an embodiment, the control device 600 has a structure 80 containing a cavity 78 sized and shaped to slidingly receive the cylindrical protrusion 74 of the backplate 70. In an embodiment, the backplate 70 may further comprise an alignment dowel 72 which is sized and shaped to be slidingly received into a cavity 76 in the control device 600. In an alternate embodiment, the cavities 76 and 78 may be in the backplate 70 and the cylindrical protrusion 74 and alignment dowel 72 may be part of the control device 600. In another alternate embodiment, the backplate 70 has at least one alignment mechanism and at least one cavity, with at least-one corresponding cavity and at least one corresponding alignment mechanism integrated into the control device 600.

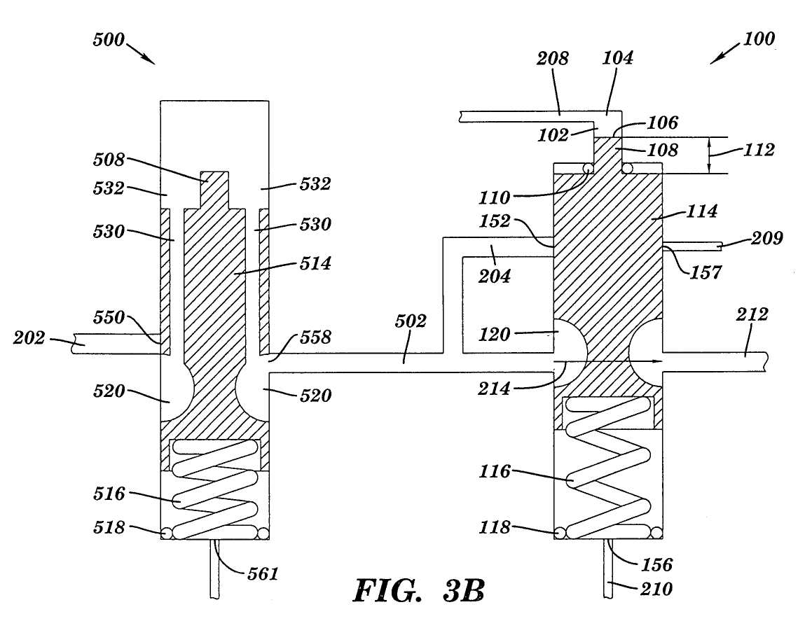

FIG. 2 shows an embodiment of a control device 600 in a semi-diagrammatic view. An embodiment of the control device 600 includes a shutoff valve 100 that can shut off the flow 214 of compressible fluid to the motor at a pre-determined time after the beginning of flow of compressible fluid through the control device 600. The control device 600 further includes a regulator valve 500 that can limit the maximum fluid pressure that is ultimately provided to the tool motor 14. In the embodiment of FIG. 2, compressible fluid flows through an input port 250 into a first channel 202, through the regulator valve 500, then through an intermediate channel 502, then through the biased-open shut-off valve 100, into and through a second channel 212, and is discharged from port 252 into the inlet 58 (FIG. 1A) of the motor 14 of the tool 10.

The regulator valve 500 comprises a valve chamber 520, a valve body 514, a biasing mechanism 516, and seals 518. The valve chamber 520 has ports 550, 558 to a plurality of channels 202, and 502. The first port 550 that is connected to channel 202 is located higher up along the exterior of the valve 500 than the second port 558 which leads to the intermediate channel 502. The valve body 514 which fits slidingly within the valve chamber 520 has at least one passage 530. In the embodiment shown in FIG. 2, the valve body 514 has one degree of freedom of translational motion. In this embodiment, the valve body 514 may also have one degree of freedom of rotational motion because the valve body 514 has rotational symmetry about its long axis. The rotational symmetry of the valve body 514 obviates the need for the valve body 514 to maintain a specific rotational orientation within the valve chamber 520 during operation. The degree of freedom of motion which opens and closes the valve 500 is the operational degree of freedom. In alternate embodiments, the valve body 514 and valve chamber 520 may not be rotationally symmetric. In other alternate embodiments, a valve 500 operates by sliding rotationally instead of translationally. Those having skill in the art will realize the advantages of minimizing the mass of the valve body 514 within the other design constraints. The biasing mechanism 516 is any mechanism or combination of mechanisms that exerts force on the valve body 514 in one direction aligned to the operational degree of freedom of motion of the valve body 514 and over at least a portion of the range of valve body 514 motion. The biasing mechanism 516 is typically a spring, but may be a compressible fluid or other elastic members.

In the embodiment of FIG. 2, a first end of the valve body 514 of the regulator valve 500 has an extension 508. The extension 508 is a rotationally symmetric extension of the valve body 514 with a uniform and smaller diameter than the maximum diameter of the valve body 514. The extension 508 typically has a predetermined length. When the valve body 514 is in its biased position, the extension 508 bears against an end of the valve chamber 520, thereby creating a chamber 532. The chamber (or actuating chamber) 532 may be considered a further extension of the valve chamber 520. The end surface of the valve body 514 is exposed to the pressure of compressible fluid which may be received in the chamber 532 via the at least one passage 530. The chamber 532 is in fluid communication, via the passages 530, with the ports 550, 558 and valve chamber 520. Thus, as fluid enters via first channel 202 through port 550, it further enters, via passage 530, to the chamber 532. The pressure of the fluid accumulating in the chamber 532 exerts a force on the end surface of the valve body 514 and the extension 508 of the valve body 514 and, thereby, on the valve body 514 itself. This exerted pressure counteracts the bias provided by the spring 516.

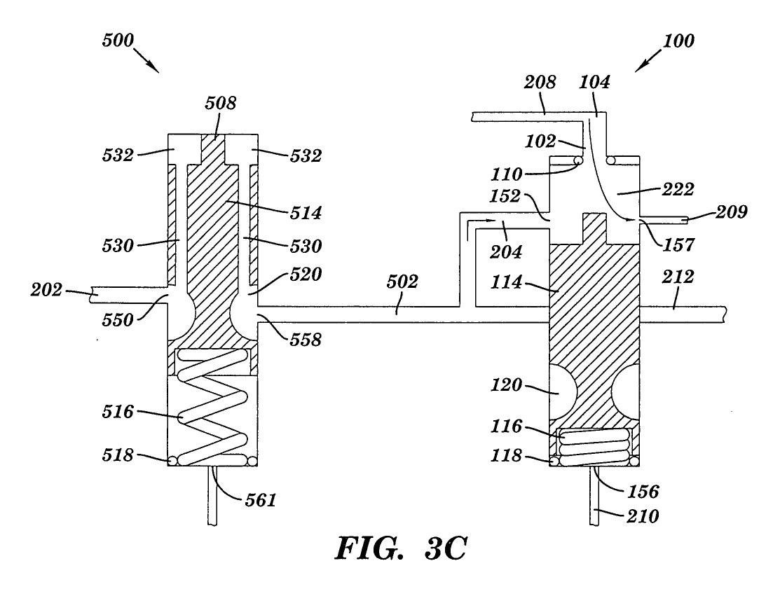

The regulator valve 500 further-includes a vent 561, which is an opening to atmospheric pressure. The vent 561 is in constant fluid communication with the valve chamber 520. Therefore, as fluid enters the valve chamber 520 and ultimately the actuating chamber 532, enough fluid pressure is built up to counteract the bias of the spring 516. When the fluid pressure within the actuating chamber 532 exceeds the force of the spring 516, the valve body 514 moves so that the ports 550 is closed, effectively closing the flow of fluid from the channel 202 through the regulator valve 500. However, because of the off-set relationship between port 550 and port 558, when the valve body 514 moves to close port 550, port 558 remains open to intermediate channel 502, thereby allowing the fluid pressure to dissipate from the chamber 532, passage 30, and valve chamber 520. Further, because the regulator valve 500 is provided with a vent 561, any fluid pressure built up on the spring side of the valve body 514 is ultimately dissipated through the vent 561. After this egress of fluid pressure out of port 558, the valve body 514 will reset in the open position due to the bias of the spring 516. The regulator valve's continual opening (See e.g. FIG. 3A), closing to incoming fluid from channel 202 while concurrently draining of the fluid pressure from within the valve 500 (See e.g. FIG. 3B), and subsequent resetting/reopening of the valve 500 (See e.g., FIG. 3C) is what allows the regulator valve 500 to constantly “hunt” for a fixed maximum fluid pressure that ultimately is provided to the motor 14. Thus, should the fluid pressure being sent to the regulator valve 500 exceed the maximum pressure of the valve 500, the valve body will continually, open and shut, thereby acting as a regulating device so as to not allow fluid flow above the designed, or maximum pressure, of the valve 500 to reach the tool motor 14.

In this manner, the regulator valve 500 serves to constantly regulate the flow of the fluid from channel 202 to intermediate channel 502, and ultimately to the motor 14. The amount of fluid pressure at which the regulator valve 500 operates may be a function of many elements including the size of the spring 516 and the area of the face of the valve body 514 that is facing the actuating chamber 532. For example, the regulator valve 500 may be designed to regulate the air pressure that ultimately passes to the motor 14 to be a maximum of 90 p.s.i. That is, should the air pressure being provided at the first channel 202 be, for example, 125 p.s.i., the regulator valve 500 would automatically, and effectively constantly, limit, or reduce, the air pressure that would leave the regulator valve 500 via the intermediate channel 502 to no more than 90 p.s.i. The valve body 514 would systematically open and shut, as required, to disallow air flow above 90 p.s.i. to reach the tool motor 14. Similarly, if for example, the fluid pressure being provided to the first channel 202 were only 75 p.s.i., this same “90 p.s.i. limit” regulator valve 500 would never receive air pressure adequate enough to overcome the spring 516 bias, and thus, would stay open constantly.

The intermediate channel 502 leads from port 558 of the regulator valve 500 to port 150 of the shut-off valve 100. Additionally extending from the intermediate channel 502 to the shut-off valve 100, is another channel 204, referred to as a “leg”, or “latch”, channel 204. The latch channel 204 connects to the shut-off valve 100 at port 152.

The shut-off valve 100 comprises a valve chamber 120, a valve body 114, a biasing mechanism 116, and seals 110 and 118. The valve chamber 120 has ports 150, 152, 154, 156, 157, 158 to a plurality of channels 502, 204, 208, 209, 210, and 212. The valve body 114 fits slidingly within the valve chamber 120. In the embodiment shown in FIG. 2, the valve body 114 has one degree of freedom of translational motion. In this embodiment, the valve body 114 may also have one degree of freedom of rotational motion because the valve body 114 has rotational symmetry about its long axis. The rotational symmetry of the valve body 114 obviates the need for the valve body 114 to maintain a specific rotational orientation within the valve chamber 120 during operation. The degree of freedom of motion which opens and closes the valve 100 is the operational degree of freedom. In alternate embodiments, the valve body 114 and valve chamber 120 may not be rotationally symmetric. In other alternate embodiments, a valve 100 operates by sliding rotationally instead of translationally. Those having skill in the art will realize the advantages of minimizing the mass of the valve body 114 within the other design constraints. The biasing mechanism 116 is any mechanism or combination of mechanisms that exerts force on the valve body 114 in one direction aligned to the operational degree of freedom of motion of the valve body 114 and over at least a portion of the range of valve body 114 motion. The biasing mechanism 116 is typically a spring, but may be a compressible fluid or other elastic members.

In the embodiment of FIG. 2, a first end of the valve body 114 of the shut-off valve 100 has a poppit portion 108. The poppit portion 108 is a rotationally symmetric extension of the valve body 114 with a uniform and smaller diameter than the maximum diameter of the valve body 114. The poppit portion 108 has a predetermined length 112. When the valve body 114 is in its biased position, the poppit portion 108 is received slidingly into a correspondingly narrowed portion 102 of the valve chamber 120. The narrowed portion 102 of the valve chamber 120 may be made longer than the poppit portion 108 of the valve body 114, in order to form a chamber 104 for receiving compressible fluid from the reservoir 400. The reservoir 400 is a cavity for accumulating compressible fluid. The receiving chamber (or actuating chamber) 104 may be considered a further extension of the valve-chamber 120. In an alternate embodiment, the receiving chamber 104 may be wider than the diameter of the poppit portion 108 of the valve body 114. In another embodiment, the receiving chamber 104 may be an extension of the fifth channel 208 which connects the reservoir 400 to the poppit end, or biased end, of the valve chamber 120. In yet another embodiment, there is no discrete receiving chamber 104, as the narrow poppit portion of the valve chamber 120 is a port directly into the reservoir 400. The end surface 106 of the poppit portion 108 is exposed to the pressure of compressible fluid which may be received in the receiving chamber 104. The pressure of the fluid in the reservoir 400 exerts a force on the end surface 106 of the poppit portion 108 of the valve body 114 and, thereby, on the valve body 114 itself. The receiving chamber 104 may be regarded as an expandable and contractible chamber having one moveable wall, the moveable wall being the end surface 106 of the poppit portion 108 of the valve body 114. In an embodiment wherein the valve operates by rotation, the actuating chamber 104 may be completely separate from the main valve chamber.

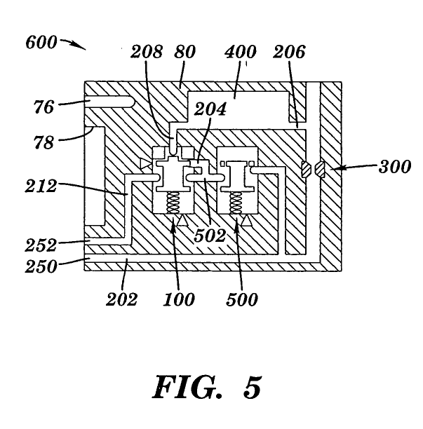

The pressure of the compressible fluid at a given time in the reservoir 400 depends, in the first instance, on the rate of flow into the reservoir 400. The rate of flow is controlled by a metering device 300. The metering device 300 may be either fixed or user-adjustable. For example, the metering device 300 may be a fixed orifice, as depicted in FIG. 5, which will control the rate of flow to a fixed, pre-determined amount depending on the attributes (e.g., size, diameter, configuration, material, etc.) of the fixed orifice 300. In this type of embodiment, the user cannot adjust the rate of flow of the metering device 300. Alternatively, the metering device 300 may a device which allows for the user to adjust and to define, perhaps within certain parameters, the rate of flow. One embodiment of a metering device 300 which allows for user adjustment is a needle valve 300 (See e.g., FIGS. 1B, 1C, and 2). The needle valve 300 comprises a needle valve seat 304 within a third channel 206, a needle valve body 302, and a user-accessible extension of the needle valve 306. The needle valve seat 304 comprises a channel portion tapered concentric to the needle valve body 302, a shaft bearing to hold the shaft of the needle valve body 302, and a seal to prevent leakage through the shaft bearing. The third channel is the reservoir input channel. In an embodiment, the threaded extension 306 is screwed into a threaded portion 308 of the third channel 206. In an alternate embodiment, the extension 306 is provided with a locking mechanism, for example: a set screw, to prevent vibrations caused by operating the tool to change the setting. The user selects the amount of time between the introduction of compressible fluid into port 250 (as by squeezing the trigger 60 (FIG. 1A)), and the closing of the poppit valve 100 by adjusting the needle valve 300. The higher the rate of flow, the faster the reservoir 400 reaches a pressure sufficient to close the shut-off valve 100.

Referring now to FIGS. 3A-C, at a point in the operating cycle where the pressure of the compressible fluid in the receiving chamber 104 exerts more force on the valve body 114 than the biasing mechanism 116, the valve body 114 begins to move against the bias (FIG. 3A). At or near the boundary between the poppit-receiving portion 102 of the valve chamber 120 and the remaining valve chamber 120, the valve chamber has a seal 110. The seal 110 prevents pressure leakage from the receiving chamber 104 into the remaining valve chamber 120 while the valve body 114 moves against the bias for the predetermined length 112 of the poppit portion 108. The valve body 114 moves against the bias by the force exerted on the end surface 106 of the poppit portion 108 by the compressible fluid from the reservoir 400 as it reaches the receiving chamber 104. As shown in FIG. 3B, when the valve body 114 moves against the bias more than the predetermined length 112 of the poppit portion 108, the seal 110 is avoided, exposing the entire area determined by the cross-section of the valve body 114 to the pressure from the reservoir 400 through receiving chamber 104. The equal pressure on the increased area creates a steep increase in the anti-bias force, thereby slamming the valve body 114 into the anti-biased (closed) position (FIG. 3C). The valve body has a channel through which the compressible fluid flows 214 from the intermediate channel 502 to the second channel 212 when the valve 100 is open (FIG. 3A). This channel is made wider than the valve chamber ports 150 and 158 (FIG. 2) for the intermediate channel 502 and second channel 212 so that flow 214 through the valve 100 is unaffected by the initial anti-bias motion for the predetermined length 112 of the poppit portion 108 (FIGS. 3A-B). Thus, from the perspective of the fluid flow 214 through the valve 100, nothing happens until the valve body 114 slams shut (closes) (FIG. 3C).

When the valve 100 closes (FIG. 3C), port 152 and vent port 157 are exposed (opened) to the portion of the valve chamber 120 at the biased end of the valve chamber 120. The biased end of the valve chamber 120 is the end of the valve chamber 120 where the valve body 114 rests when the force exerted by the biasing mechanism 116 predominates, as shown in FIG. 3A. When the valve body 114 was in the biased position, or within a predetermined poppit portion 108 length 112 of the biased position, port 152 and vent port 157 are closed by surfaces of the valve body 114. Vent port 156 is always open, regardless of the position of the valve body 114. When the valve body 114 moves to the anti-biased position, as shown in FIG. 3C, the port 152 and vent port 157 open. Port 152 receives compressible fluid from the latch channel 204. The latch channel 204 connects the intermediate channel 502 (the fluid input channel, FIG. 2) to the valve chamber 120 when the valve body 114 is in the anti-biased position (FIG. 3C). The compressible fluid from the latch channel 204 provides sufficient pressure to “latch” the valve 100 in the anti-biased position. The vent port 157 is always open, thereby venting the valve chamber when the valve body 114 is in the anti-biased position. Thus, when the user stops pulling the trigger 60 of the tool 14, the configuration of port 152 and vent port 157 allows for the draining of any fluid, and fluid pressure, from the reservoir 400 to the atmosphere. The flow of fluid from the valve 100 and reservoir 400 is denoted by arrow 222. This latch channel 204, upon the stopping of the trigger 60 pull, thereby allows the valve body 114 to reset into the biased, or open position (See FIG. 3A).

The other vent port 156 in the valve chamber 120″ which is always open, prevents the excessive fluid pressure buildup from the spring-side of the valve body 114. The vent port 156 discharges compressed fluid into vent channel 210. The vent channel 210 leads to open air, in the case of a pneumatic device, or to a return line in the case of compressible fluids not normally released into the atmosphere, such as hydraulic fluid or dry nitrogen. In any embodiment, the vent channel 209 prevents compressible fluid 222 and 224 and its excessive pressure from the valve chamber 120 and reservoir 400 (FIG. 2) through fifth channel 208 and receiving chamber 104 to dissipate. The vent channel 209 is sufficiently narrow, as compared with the latching channel 204 that the valve 100 will remain latched for as long as compressible fluid that is dissipating exceeds in pressure the pressure that the bias spring 116 exerts. However, when the supply of compressible fluid is shut off, as by releasing the trigger 60 (FIG. 1A) in the present embodiment, the vent 209 dissipates 222 and 224 the pressure from the valve chamber 120 and reservoir 400, allowing the biasing force on the valve body 114 to once again predominate and move the valve body 114 back to its biased position (FIG. 3A).

As shown in FIGS. 3A-C, the regulator valve 500 and shut-off valve 100 are shown in various positions.

In FIG. 3A, the fluid flow through both valves 500, 100 is adequate and reaches the motor 14, via the first channel 202, intermediate channel 502, and channel 212. FIG. 3B depicts how the valve body 514 in the regulator valve 500 has shut due to excessive air pressure being provided from the first channel 202. Likewise, FIG. 3C depicts how the regulator valve 500 is opened again, due to the venting of the excessive air pressure via the intermediate channel 502, and air is allowed to proceed on to the shut-off valve 100 (and beyond to the tool motor 14 in FIGS. 3A, 3B).

The biasing mechanism 116 may be a spring. At the anti-biased end of the valve chamber 120, a ring seal 118 provides a bumper for the valve body 114 as it closes. In an embodiment, the ring seal 118 may also aid in sealing the junction between a part of the control device 600 (FIG. 1B) containing most of the valve chamber 120, and a second part forming the anti-biased end of the valve chamber 120. In the embodiment of FIGS. 3A-C, the anti-biased end of the valve body 114 has a recess for receiving one end of a coil spring 116. The recess aids in maintaining the alignment of the spring 116 during operation.

Referring back to FIG. 2, the first channel 202 also has a port 160 into a third channel 206. The third channel 206 provides restricted flow of compressible fluid from the first channel 202 to the reservoir 400. In the embodiment of FIG. 2, the flow restriction is a variable flow restriction wherein the amount of flow restriction is determined by the position of a user-adjustable needle valve 300. An alternative embodiment includes a fixed orifice in lieu of a user-adjustable needle valve 300 Compressible fluid from the third channel 206 flows through the flow restriction into a reservoir 400. The reservoir 400 accumulates compressible fluid, increasing the pressure within the reservoir 400. The reservoir 400 has an outlet through a fifth channel 208 which leads to the receiving chamber 104 portion of the valve chamber 120. The pressure in the receiving chamber 104 exerts a force on an end surface 106 of the poppit portion 108 of the valve body 114. The pressure-derived force opposes the biasing force on the valve body 114.

The rate at which the reservoir fills with compressible fluid is determined by the flow restriction. The nearer the needle valve 300 is to being closed, the longer it takes for the reservoir 400 to accumulate enough fluid to create enough pressure to exert enough force to overcome the biasing force on the valve body 114. Thus the needle valve 300 position determines the amount of time between the beginning of fluid inflow (when the operator squeezes the trigger 60 (FIG. 1A) on a pneumatic torque wrench, for example) and the latching of the valve 100, which shuts off the motor 14 of the tool 10. In addition to minimizing wasted energy and avoiding over-torque conditions by time-limiting tool operation, the needle valve 300 adjustment can be used to compensate for the inevitable changes in the properties of the valve spring 116 over the life of the tool 10. Likewise, the needle valve 300 can be adjusted to provide different times for different work situations. For example, tightening an eight-inch-long bolt would take more time than tightening a one-inch-long bolt.

Referring again to FIGS. 1A and 1B, the valve 100, needle valve 300, and channels 202, 204, 206, 208, 212, and 502 are contained within a modular structure 80 designed to be aligned with and releasably attached to a tool 10. The alignment mechanisms 72, 74, 76, and 78 comprise means to ensure that the input port 250 and discharge port 252 of the control device 600 mate sealingly with the fluid supply port 56 and the motor inlet port 58 of the tool 10, respectively. In an embodiment, the backplate 70 of the tool 10 has a cylindrical extension 74 that fits into a corresponding recess 78 in the control device 600. The backplate 70 is further equipped with at least one asymmetrically arranged rod 72 corresponding to at least one hole 76 in the control device 600. The rods 72 are arranged asymmetrically so that there is only one orientation of the control device 600 that will allow the apparatus 600 to be received onto the tool 10. That orientation is the orientation at which the ports of the apparatus 250 and 252 and the tool will line up properly. The attachment mechanism may be as simple as a bolt through the control device into a threaded hole in the tool. Those skilled in the art of tool manufacture will be aware of many different ways of making the attachment. The requirements for the attachment mechanism are that it create a seal against leakage of the compressible fluid and that it be reusable.

In a particular embodiment, a control device 600 is integrated with a handle 12 comprising a trigger valve 62 and 60 and associated channel 50, port 52, and fitting 54. In this embodiment, the motor 14 and elements of a drive train from a drive shaft of the motor 14 to an output fitting are modular and releasably attach to the integrated handle 12 and control device 600. This embodiment provides so that all of the elements controlling the flow of energy to the motor 14 are in one module. In alternative embodiments the control device 600 can be non-modular, that is integrated into one, or more parts of the tool 10.

Referring to FIG. 1C, the body of the an embodiment of control device 600 may be manufactured from two or more blocks (also called parts or sub-blocks) 82 and 84. In an embodiment, the first block 84 is machined to contain the valve chamber 120 (FIG. 2), reservoir 400, the alignment holes 76 and 78, attachment mechanisms, the input and discharge ports 250 and 252, and all channels except the third channel 206. All of the features of the first block 84 can be formed by drilling and machining. The second block-82 contains the third channel 206 and the needle valve 300. The third channel 206 may be formed by drilling and machining. In assembly, the spring 116 and bumper seal 118 are inserted before the valve body 114, and an annular chamber end 180 with the poppit seal 110 after the valve body 114. Annular chamber end 180 forms the receiving chamber 104 and the valve chamber extension 102. Installation of the needle valve 300 requires at least one seal (not shown). Assembling the two blocks 82 and 84 together closes the valve chamber 120 and reservoir 400. The blocks 82 and 84 may be bolted together or affixed by permanent means, such as welding. A releasable assembly (bolts) is generally preferred, as it enables maintenance and refurbishment of the valve 100.

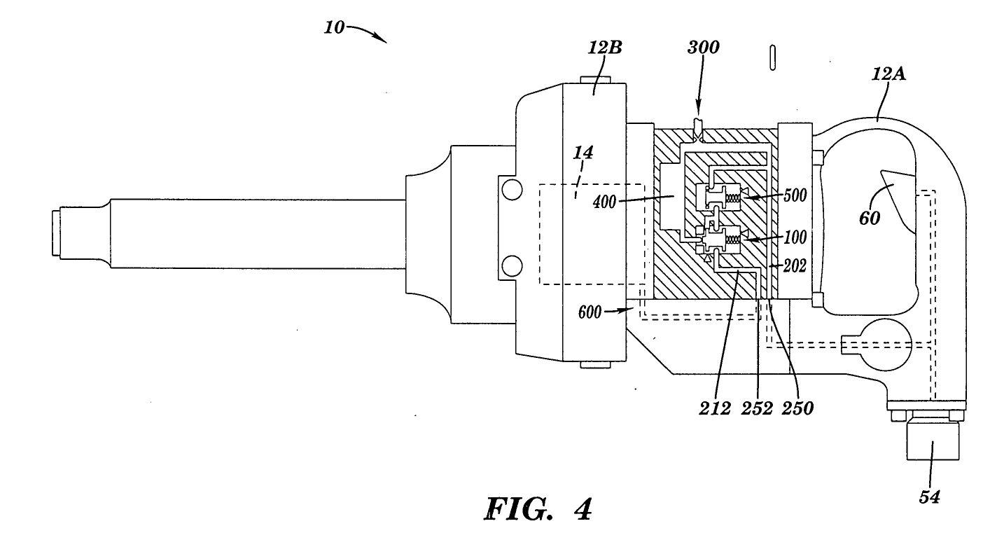

FIG. 4 depicts a sectional elevation of a tool 10, in this particular embodiment a D-handled, or spade handled tool. Similarly, the control device 600 may be integrated into the body of the tool 10.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A control device for use with a pneumatic torque control tool having a motor, said device comprising:
a pressure regulator, configured to limit a maximum pneumatic pressure provided to said motor; and
a torque limiting timing device, configured to shut off fluid flow to said motor at a predetermined time.

2. The control device of claim 1, wherein said predetermined time is user adjustable.

3. The control device of claim 1, wherein said predetermined time is fixed.

4. The control device of claim 1, wherein said pressure regulator is a regulator valve.

5. The control device of claim 1, wherein said torque limiting timing device is a shut-off valve.

6. The control device of claim 1, wherein said device is releasably attachable to said tool.

7. The control device of claim 1, wherein said device is modular.

8. The control device of claim 1, wherein said device is integral with said tool.

9. The control device of claim 1, wherein said device is remote from said tool.

10. A pneumatic tool, comprising:
a housing;
a motor within the housing; and
a control device in fluid communication with the motor, wherein said control device includes a pressure regulator, configured to limit a maximum pneumatic pressure provide to said motor; and a torque limiting timing device, configured to shut off fluid flow to said motor at a predetermined time.

11. The pneumatic tool of claim 10, wherein said control device is releasably attached to said housing.

12. The pneumatic tool of claim 10, wherein said control device is integrated within said housing.
